(19) United States
(12) Patent Application Publication
(10) Pub. No.: US 2023/0302620 A1
(43) Pub. Date: Sep. 28, 2023

(54) ROTARY POWER TOOL

(71) Applicant: MILWAUKEE ELECTRIC TOOL CORPORATION, Brookfield, WI (US)

(72) Inventors: Travis J. Dubnicka, Menomonee Falls, WI (US); Erik A. Freeberg, Oconomowoc, WI (US)

(21) Appl. No.: 18/127,172

(22) Filed: Mar. 28, 2023

Related U.S. Application Data
(60) Provisional application No. 63/324,465, filed on Mar. 28, 2022.

(51) Int. Cl. B25F 5/00; B25F 5/02

(52) U.S. Cl. CPC B25F 5/001; B25F 5/02

(57) ABSTRACT

A power tool includes a main housing defining a handle, a spindle housing coupled to the main housing, and a drive mechanism positioned at least partially within the main housing and the spindle housing. The drive mechanism includes a motor having a motor shaft, a spindle having a first end and a second end defining a tool holder, the tool holder configured to receive a tool bit, and a coupler positioned between the motor shaft and the spindle for transmitting torque therebetween, the coupler having a recess defined therein. A spindle lock is coupled to the spindle housing, wherein the spindle lock is biased towards an unlocked position and movable toward a locked position in which the spindle lock is engaged with the recess to restrict rotation of the spindle and the motor shaft.

### CROSS-REFERENCE TO RELATED APPLICATIONS

This application claims priority to co-pending U.S. Provisional Patent Application No. 63/324,465 filed on Mar. 28, 2022, the entire content of which is incorporated herein by reference.

### FIELD OF THE DISCLOSURE

The present disclosure relates to power tools, and more particularly to portable rotary power tools.

### BACKGROUND OF THE INVENTION

Many of the portable grinding tools that are currently available and that run at high operating speeds, such as 20,000 revolutions per minute (rpm) or greater, are pneumatic tools. Pneumatic motors powering these tools typically have very short output shafts that do not create significant vibration at such high operating speeds (e.g., from 20,000 to 24,000 rpm). High-speed power tools using electric motors, however, typically have a relatively long rotor shaft and output shaft. Due to the dimensions and the flexibility of this longer shaft, at high operating speeds, the shaft tends to vibrate at resonant frequencies that shake the tool.

### SUMMARY OF THE INVENTION

The present invention provides, in one aspect, a power tool including a main housing defining a handle, a spindle housing coupled to the main housing, and a drive mechanism positioned at least partially within the main housing and the spindle housing. The drive mechanism including a motor having a motor shaft, a spindle having a first end and a second end defining a tool holder, the tool holder configured to receive a tool bit, and a coupler positioned between the motor shaft and the spindle for transmitting torque therebetween, the coupler having a recess defined therein. A spindle lock coupled to the spindle housing, wherein the spindle lock is biased towards an unlocked position and movable toward a locked position in which the spindle lock is engaged with the recess to restrict rotation of the spindle and the motor shaft.

The present invention provides, in another aspect, a power tool including a main housing defining a handle, a spindle housing coupled to the main housing, the spindle housing having an inner spindle housing and an outer spindle housing, and a drive mechanism positioned at least partially within the main housing and the spindle housing. The drive mechanism including a motor having a motor shaft, and a spindle having a first end coupled to the motor shaft and a second end defining a tool holder, the tool holder configured to receive a tool bit. A damper positioned between the inner spindle housing and the outer spindle housing. The damper is configured to attenuate transmission of vibration from the inner spindle housing to the outer spindle housing, and wherein the damper longitudinally extends along the inner spindle housing or the outer spindle housing.

The present invention provides, in another aspect, a power tool including a main housing defining a handle, a spindle housing coupled to the main housing, the spindle housing having an inner spindle housing and an outer spindle housing, and a drive mechanism positioned at least partially within the main housing and the spindle housing. The drive mechanism including a motor having a motor shaft, a spindle having a first end and a second end defining a tool holder, and a coupler positioned between the motor shaft and the spindle for transmitting torque therebetween, the coupler having a dampening portion configured to attenuate vibration of the spindle, and a damper positioned between the inner spindle housing and the outer spindle housing. The damper longitudinally extends along the inner spindle housing or the outer spindle housing.

Other features and aspects of the invention will become apparent by consideration of the following detailed description and accompanying drawings.

### BRIEF DESCRIPTION OF THE DRAWINGS

FIG. 1 is a perspective view of a portable rotary power tool, such as a die grinder.

FIG. 2A is an exploded perspective view of the die grinder of FIG. 1.

FIG. 2B is an enlarged view of a portion of the die grinder of FIG. 2A.

FIG. 3 is a side cross-sectional view of a portion of the die grinder of FIG. 1.

FIG. 4 is a perspective cross-sectional view of a portion of the die grinder of FIG. 1.

FIG. 5 is another perspective cross-sectional view of a portion of the die grinder of FIG. 1.

FIG. 6 is a perspective view an outer spindle housing of the die grinder of FIG. 1, illustrating a vibration damper.

FIG. 7 is a perspective view an inner spindle housing of the die grinder of FIG. 1, illustrating a vibration damper.

FIG. 8 is a side view of the die grinder of FIG. 1 with a flexible tool shaft coupled to the grinder.

FIG. 9 is a side view of the flexible tool shaft.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

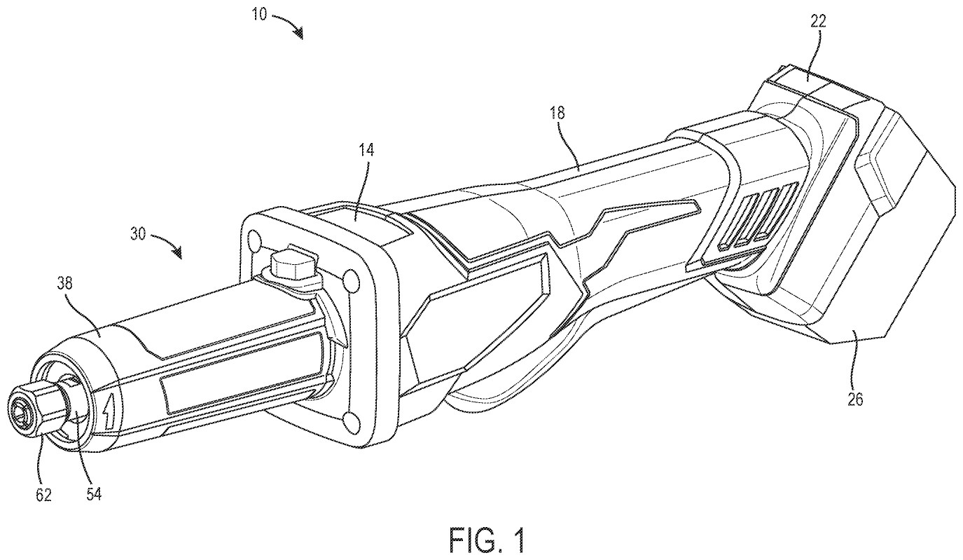

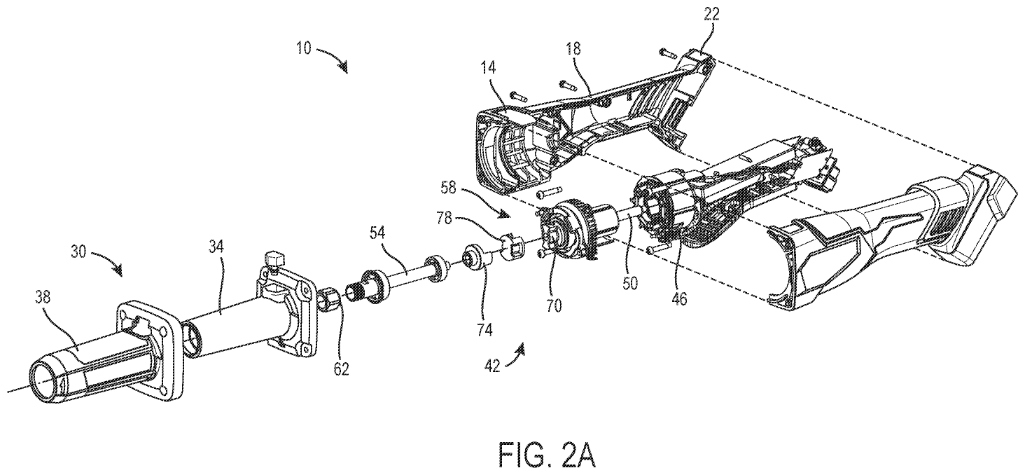

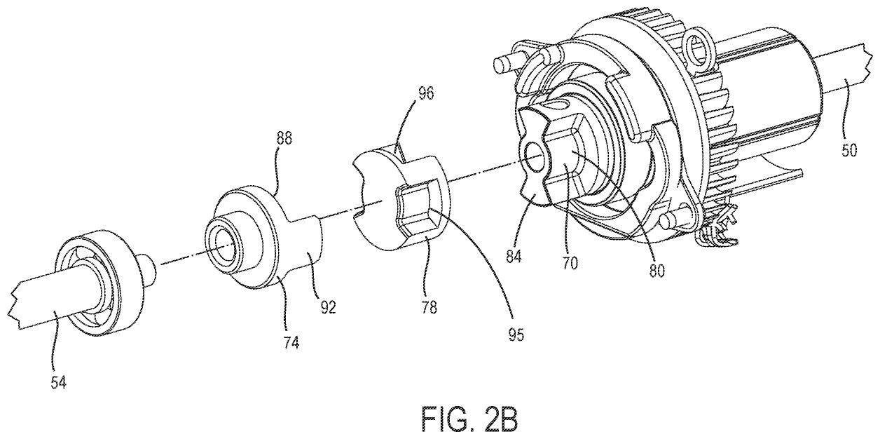

FIGS. 1 and 2A illustrate a portable powered grinding tool, such as a die grinder 10, according to an embodiment of the invention. As shown in FIGS. 1 and 2, the die grinder 10 includes a main housing 14 defining a handle 18, and a battery receptacle 22. The battery receptacle 22 is configured to selectively mechanically and electrically connect to a rechargeable battery pack 26 for powering a drive mechanism 42 (FIG. 2). The battery pack may include any of a number of different nominal voltages (e.g., 12V, 18V, etc.), and may be configured having any of a number of different chemistries (e.g., lithium-ion, nickel-cadmium, etc.). In alternative embodiments (not shown), the drive mechanism 42 may be powered by a remote power source (e.g., a household electrical outlet) through a power cord. The main housing 14 further contains control electronics for the grinder 10 (e.g., a PCBA, a microswitch, a trigger (not shown), etc.).

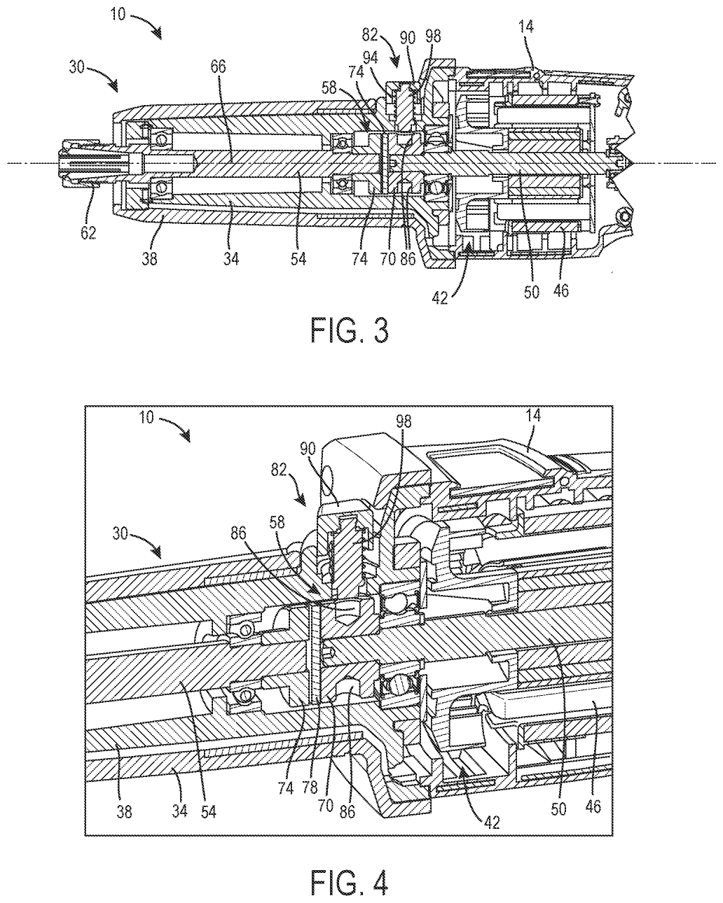

With reference to FIGS. 2A, 2B, and 3, a spindle housing 30 is coupled to the main housing 14. In the illustrated embodiment, the spindle housing 30 includes a first, inner spindle housing 34 (FIG. 2A) and a second, outer spindle housing 38 surrounding the inner spindle housing 34. The drive mechanism 42 is positioned at least partially within the main housing 14 and the spindle housing 30. The drive mechanism 42 includes a motor 46 having a motor shaft 50 and an output shaft or spindle 54 coupled to the motor shaft 50 via a coupler 58. In the illustrated embodiment, the motor 46 is a direct current (DC) motor. The spindle 54 includes a first end coupled to the coupler 58 and a second, distal end defining a tool holder 62 that is configured to axially and rotatably secure a tool bit to the spindle 54 (e.g., a grinding disc, a rotary burr, etc.). In the illustrated embodiment, a drive axis 66 (FIG. 3) extends centrally through the motor shaft 50 and the spindle 54.

The spindle 54 is surrounded by the spindle housing 30, which the operator may grasp during operation. In the illustrated embodiment, the coupler 58 is an inline torsional damper that attenuates vibration of the spindle 54. The coupler 58 therefore reduces the amount of vibration transferred to the motor shaft 50 and the handle 18 during operation. The coupler 58 includes a first portion 70 coupled for co-rotation with the motor shaft 50, a second portion 74 coupled for co-rotation with the spindle 54, and a third, dampening portion 78 positioned between the first and second portions 70, 74. In the illustrated embodiment, the first portion 70 includes alternating recesses 80 and protrusions 84, and the second portion 74 includes alternating recesses 88 and protrusions 92. The alternating recesses 80 and protrusions 84 of the first portion 70 engage with the alternating recesses 88 and protrusions 92 of the second portion 74 in a keyed fashion (FIG. 2B) to transmit torque from the motor shaft 50 to the spindle 54.

In the illustrated embodiment, the dampening portion 78 is positioned between the first and second portions 70. The dampening portion 78 further includes a recess 95 configured to receive the protrusion 92 of the second portion 74 and a recess 96 that receives the protrusions 84 of the first portion 70. In other words, the dampening portion intermediately couples the first and second portions 70, 74 together. In other embodiments, the coupler 58 may be devoid of the dampening portion 78. The dampening portion 78 may be formed of any material that is capable of dampening vibration while transmitting torque from the motor shaft 50 to the spindle 54. For example, the first and second portions 70, 74 may be formed of a relatively hard plastic material (e.g., ABS, PA, PP, PC, etc.), whereas the dampening portion 78 may be formed from a relatively softer material (e.g., a thermoplastic elastomer, rubber, etc.). In other words, the first and second portions 70, 74 may be formed of a first material having a first hardness, whereas the dampening portion 78 may be formed of a second material having a second hardness that is less than the first hardness.

Now with reference to FIGS. 3-5, the grinder 10 further includes a spindle lock 82 coupled to the spindle housing 30. The spindle lock 82 is urged towards an unlocked position and may be actuated to selectively engage a recess 86 formed in the coupler 58 to restrict rotation of the spindle 54 and the motor shaft 50. Restricting rotation of the spindle 54 allows the operator to install or remove the tool bit to/from the tool holder 62.

The spindle lock 82 includes a button 90 biased by a biasing member 94 (e.g., a spring) and a lock shaft 98 to the button 90 at an outer end. An inner end of the lock shaft 98 is configured to selectively engage the recess 86 when the button 90 is actuated (i.e., depressed) to rotationally lock the motor shaft 50 and the spindle 54 to insert or remove the tool bit from the tool holder 62. The recess 86 is formed in the first portion 70 of the coupler 58. In the illustrated embodiment, the first portion 70 of the coupler 58 includes a pair of recesses 86 positioned approximately 180 degrees from each other. In other embodiments, the first portion 70 of the coupler 58 may include fewer (e.g., one) or more (e.g., three, four, etc.) recesses in which the lock shaft 98 can be received. In other embodiments, the recess 86 may be formed in the second portion 74 of the coupler 58.

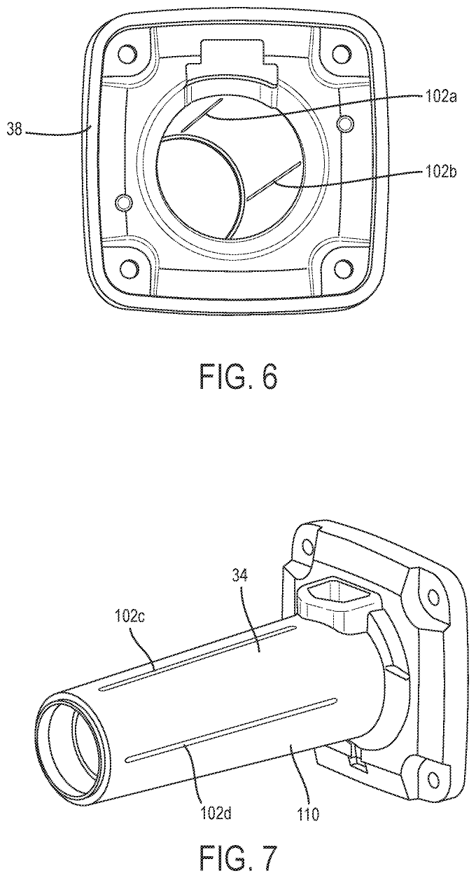

Now with reference to FIGS. 6 and 7, in some embodiments of the die grinder 10, one or more dampers 102a, 102b, 102c, 102d may be positioned between the inner spindle housing 34 and outer spindle housing 38. The dampers 102a, 102b, 102c, 102d are configured to attenuate transmission of vibration from the inner spindle housing 34 to the outer spindle housing 38, which reduces transmission of the vibration to the user when the spindle housing 30 is grasped during operation. In some embodiments, the dampers 102a, 102b, 102c, 102d may include one or more dampers 102a, 102b coupled to an internal surface 106 of the outer spindle housing 38. Additionally or alternatively, the dampers 102a, 102b, 102c, 102d may include one or more dampers 102c, 102d coupled to an external surface 110 of the inner spindle housing 34. In the illustrated embodiment, the dampers 102a, 102b, 102c, 102d are formed as molded ribs or projections that extend longitudinally along the inner spindle housing 34 or the outer spindle housing 38, or both the inner spindle housing 34 and the outer spindle housing 38. In some embodiments, the dampers 102 may be parallel to the drive axis 66 (FIG. 3). In other embodiments, the dampers 102a, 102b, 102c, 102d may be oblique to the drive axis 66.

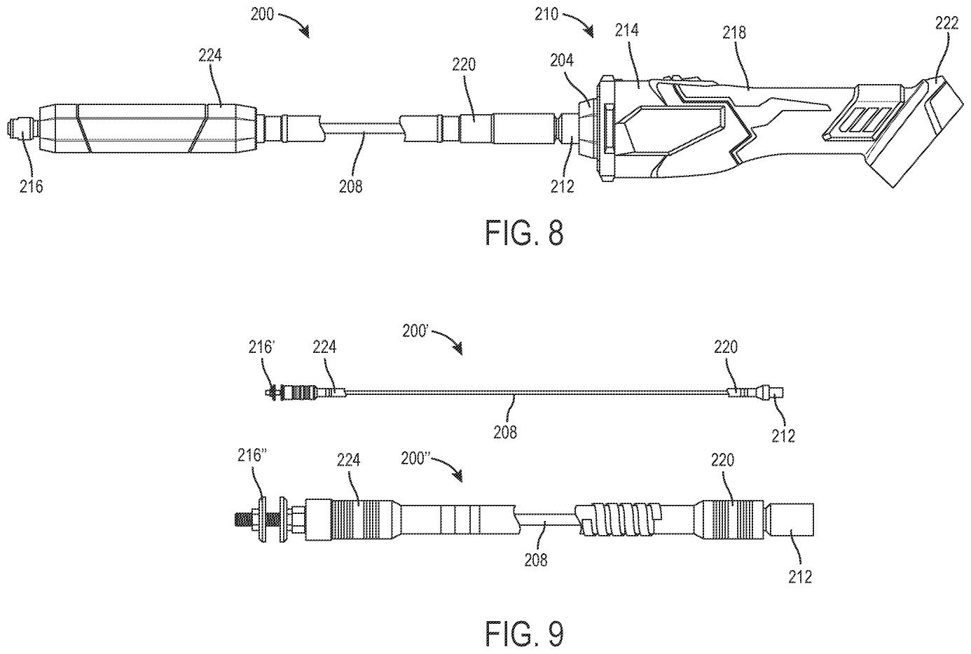

FIGS. 8 and 9 illustrate a die grinder 210 according to another embodiment of the invention. The strap die grinder 210 is like the die grinder 10 shown in FIGS. 1-7 and described above. Therefore, like features are identified with like reference numerals plus “200”, and only the differences between the two will be discussed.

The die grinder 210 includes a main housing 214 defining a handle 218, a battery receptacle 222, and a flexible shaft support housing 204. The battery receptacle 222 is configured to selectively mechanically and electrically connect to a rechargeable battery pack for powering a drive mechanism. A flexible shaft 200 may be coupled to the flexible shaft support housing 204 of the grinder 210. In some embodiments, the spindle housing 30 and the spindle 54 (FIG. 2A) of the die grinder 10 may be removed from the main housing 14 and replaced with a flexible shaft support housing 204 and the flexible shaft 200 to form the die grinder 210. In other words, the support housing 204 and the flexible shaft 200 is interchangeable with the spindle housing 204 and the spindle 54 so the die grinder 210 may be used with or without the flexible shaft 200.

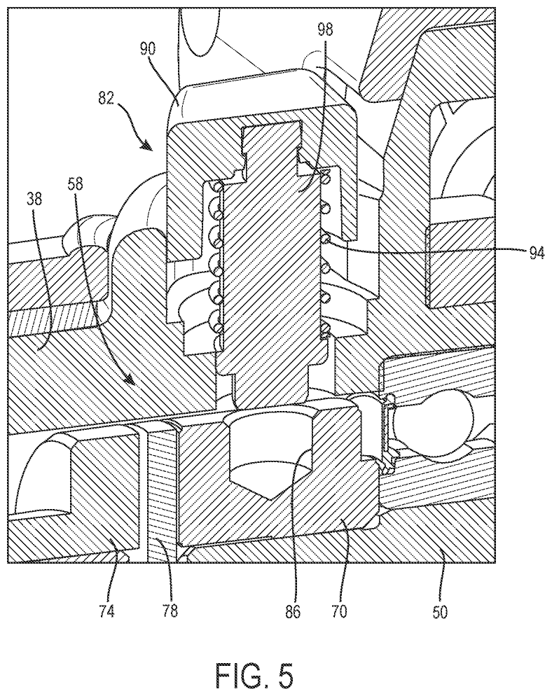

The flexible shaft 200 includes a main shaft body 208 having a first end defining a connection end 212 and a second end defining a tool holder 216. In the illustrated embodiment, the connection end 212 may be coupled to the motor (e.g., via the coupler 58; FIG. 5), which allows the motor to transfer torque to the main shaft body 208. In other embodiments, the connection end 212, may be coupled to the tool holder 62 of the spindle 54 (FIG. 1).

The tool holder 216 may include a collet (FIG. 8). In other embodiments, a tool holder 216′ of a flexible shaft 200′ (FIG. 9) may include a wheel arbor integrally formed with the main shaft body 208. In other embodiments, a tool holder 216″ of a flexible shaft 200″ (FIG. 9) may include a wheel arbor removably coupled to the main shaft body 208.

The flexible shaft 200 further includes an outer cover 220 surrounding the main shaft body 208. The outer cover 220 further defines a secondary handle 224 positioned adjacent the tool holder 216. During operation of the grinder 10, the operator may grasp the secondary handle 224 to move the tool holder 216 while holding the die grinder 210 with the other hand.

Although the invention has been described in detail with reference to certain preferred embodiments, variations and modifications exist within the scope and spirit of one or more independent aspects of the invention as described.

Various features of the invention are set forth in the following claims.

1. A power tool comprising:
a main housing defining a handle;
a spindle housing coupled to the main housing;
a drive mechanism positioned at least partially within the main housing and the spindle housing, the drive mechanism including
a motor having a motor shaft,
a spindle having a first end and a second end defining a tool holder, the tool holder configured to receive a tool bit, and
a coupler positioned between the motor shaft and the spindle for transmitting torque therebetween, the coupler having a recess defined therein; and
a spindle lock coupled to the spindle housing, wherein the spindle lock is biased towards an unlocked position and movable toward a locked position in which the spindle lock is engaged with the recess to restrict rotation of the spindle and the motor shaft.

2. The power tool of claim 1, wherein the coupler includes a first portion coupled to the motor shaft, a second portion coupled to the spindle, and a third dampening portion positioned between and coupling the first and second portions.

3. The power tool of claim 2, wherein the first portion and the second portion include alternating recesses and protrusions, and wherein the alternating recesses and protrusions engage in a keyed fashion.

4. The power tool of claim 2, wherein the first and second portions are formed of a first material having a first hardness, and wherein the third dampening portion is formed of a second material having a second hardness that is less than the first hardness.

5. The power tool of claim 2, wherein the recess is defined in the first portion of the coupler.

6. The power tool of claim 1, wherein the recess is a first recess, and wherein the coupler has a second recess positioned approximately 180 degrees from the first recess.

7. The power tool of claim 1, wherein the spindle lock is movable between the unlocked position and the locked position in a direction that is perpendicular to a drive axis of the spindle.

8. The power tool of claim 1, wherein
the spindle lock includes a button biased by a biasing member and a lock shaft operably coupled to the button, and
the lock shaft is configured to selectively engage the recess when the button is actuated.

9. A power tool comprising:
a main housing defining a handle;
a spindle housing coupled to the main housing, the spindle housing having an inner spindle housing and an outer spindle housing;
a drive mechanism positioned at least partially within the main housing and the spindle housing, the drive mechanism including
a motor having a motor shaft, and
a spindle having a first end coupled to the motor shaft and a second end defining a tool holder, the tool holder configured to receive a tool bit; and
a damper positioned between the inner spindle housing and the outer spindle housing, wherein the damper is configured to attenuate transmission of vibration from the inner spindle housing to the outer spindle housing, and wherein the damper longitudinally extends along the inner spindle housing or the outer spindle housing.

10. The power tool of claim 9, wherein the damper is parallel to a drive axis that extends centrally through the motor shaft and the spindle.

11. The power tool of claim 9, wherein the damper is coupled to an internal surface of the outer spindle housing.

12. The power tool of claim 9, wherein the damper is coupled to an external surface of the inner spindle housing.

13. The power tool of claim 9, wherein the damper is a first of a plurality of dampers, and wherein the plurality of dampers also includes a second damper, a third damper, and a fourth damper.

14. The power tool of claim 13, wherein the first and second dampers are coupled to an internal surface of the outer spindle housing, and wherein the third and fourth dampers are coupled to an external surface of the outer spindle housing.

15. A power tool comprising:
a main housing defining a handle;
a spindle housing coupled to the main housing, the spindle housing having an inner spindle housing and an outer spindle housing;
a drive mechanism positioned at least partially within the main housing and the spindle housing, the drive mechanism including
a motor having a motor shaft,
a spindle having a first end and a second end defining a tool holder, and
a coupler positioned between the motor shaft and the spindle for transmitting torque therebetween, the coupler having a dampening portion configured to attenuate vibration of the spindle; and
a damper positioned between the inner spindle housing and the outer spindle housing, wherein the damper longitudinally extends along the inner spindle housing or the outer spindle housing.

16. The power tool of claim 15, wherein the coupler has a recess defined therein, wherein the power tool further comprises a spindle lock coupled to the spindle housing, and wherein the spindle lock is biased towards an unlocked position and movable toward a locked position in which the spindle lock is engaged with the recess to restrict rotation of the spindle and the motor shaft.

17. The power tool of claim 16, wherein
the spindle lock includes a button biased by a biasing member and a lock shaft operably coupled to the button, and
the lock shaft is configured to selectively engage the recess when the button is actuated.

18. The power tool of claim 15, wherein the coupler includes a first portion coupled to the motor shaft and a second portion coupled to the spindle, and wherein the dampening portion is positioned between the first and second portions.

19. The power tool of claim 15, wherein the damper is configured to attenuate transmission of vibration from the inner spindle housing to the outer spindle housing.

20. The power tool of claim 15, wherein the damper is parallel to a drive axis that extends centrally through the motor shaft and the spindle.

21.-26. (canceled)
